(19) United States
(12) Patent Application Publication
(10) Pub. No.: US 2026/0181182 A1
(43) Pub. Date: Jun. 25, 2026

(54) METADATA CARRIAGE IMPROVEMENTS

(71) Applicant: APPLE INC., Cupertino, CA (US)

(72) Inventors: Dimitri PODBORSKI, Cupertino, CA (US); Alexandros TOURAPIS, Los Gatos, CA (US); Seethal PALURI, San Diego, CA (US); Jungsun KIM, Sunnyval, CA (US); Leo BARNES, Hoor (SE)

(21) Appl. No.: 19/377,248

(22) Filed: Nov. 3, 2025

Related U.S. Application Data
(60) Provisional application No. 63/736,665, filed on Dec. 20, 2024.
(60) Provisional application No. 63/832,122, filed on Jun. 28, 2025.

(51) Int. Cl. H04N 19/70

(52) U.S. Cl. CPC H04N 19/70

(57) ABSTRACT

Techniques are disclosed for an efficient and flexible representation of metadata instances that may be applied during media coding, decoding, and presentation. According to these embodiments, for a plurality of instances of metadata unit payloads to be signaled, a metadata group header section may be formed comprising a corresponding number of metadata unit headers and a metadata group payload section may be formed comprising the respective instances of the metadata unit payloads. The metadata unit headers may provide information that determines how the metadata unit payloads are to be processed. For example, metadata unit headers may define an order of priority among the metadata unit payloads, a persistence of the metadata unit payloads, and application(s) to which the metadata unit payloads relate.

### CLAIMS FOR PRIORITY

This application benefits from priority of application Ser. No. 63/736,665, filed Dec. 20, 2024, entitled “Metadata Carriage Improvements,” and application Ser. No. 63/832,122, filed Jun. 28, 2025, also entitled “Metadata Carriage Improvements,” the disclosures of which are incorporated herein in their entireties.

### BACKGROUND

The present disclosure relates to electronic devices and, in particular, to electronic devices that exchange representations of media with other devices.

Modern consumer electronic devices often support the exchange of media between them. The media may be from a “natural” source, for example, audio or video captured by a microphone or camera system, or it may be “synthetic” media, which may be generated by an application executing on the device. No matter the source, it often is required to apply bandwidth compression operations to the media to facilitate communication over bandwidth-constrained networks. These devices often perform their compression operations according to inter-operability standards that define how compression operations are to be performed and how the compressed data is to be represented. In this manner, devices that decompress the compressed media will be able to parse the compressed data and invert coding operations to generate a decompressed representation of the source media. The AOMedia Video 1 protocol (commonly, “AV1”), the ITU-T H.265 specification (commonly, “HEVC”), and the ITU-T H.266 specification (commonly, “VVC”) are examples of these inter-operability coding specifications for video applications.

When a destination device receives a compressed representation of the media, it applies decompression operations that (at a high level) invert the compression applied by a source device to recover the media. The compression and decompression process can incur information loss; therefore, the recovered media obtained by the destination device oftentimes is an imperfect replica of the source media that was compressed. Coding specifications can describe certain processing operations to be applied to the recovered media that may improve the perceptual quality of recovered media but even these processes can result in perceptual artifacts.

Several coding specifications provide tools that enable a source device to send to a destination device information that otherwise may be out-of-scope from the coding specification. For example, the Open Bitstream Units (OBUs) in AV1, using Metadata OBUs, and the Network Abstraction Layer (NAL) units in HEVC (ITU-T H.265), using Supplemental Enhancement Information (commonly, “SEI”) message NAL units, allow a source device to send metadata information to a destination device that may permit it to augment processes represented by coding data. However, these tools have limitations that can impact the usability and implementations/access of such metadata.

### BRIEF DESCRIPTION OF THE DRAWINGS

FIG. 1 illustrates a media exchange system according to an aspect of the present disclosure.

FIG. 2 is a simplified functional block diagram of a media encoding system according to embodiments of the present disclosure.

FIG. 3 is a simplified functional block diagram of a media decoding system according to embodiments of the present disclosure.

FIG. 4 illustrates a metadata group according to an embodiment of the present disclosure.

FIG. 5 illustrates a metadata group according to another embodiment of the present disclosure.

FIG. 6 illustrates a metadata group according to a further embodiment of the present disclosure.

FIG. 7 illustrates a metadata group according to another embodiment of the present disclosure.

FIG. 8 illustrates a metadata group according to a further embodiment of the present disclosure.

FIG. 9 illustrates a metadata group according to a yet another embodiment of the present disclosure.

FIG. 10 illustrates data elements that may be included in a metadata header according to an embodiment of the present disclosure.

FIG. 11 illustrates a metadata header according to another embodiment of the present disclosure.

FIG. 12 illustrates a coding syntax according to an embodiment of the present disclosure.

FIG. 13 illustrates an exemplary set of relationships between metadata group elements and metadata processing states that may arise as metadata group elements are processed by a destination device.

FIG. 14 illustrates a simplified hierarchy of coding elements suitable for use with the embodiments of the present disclosure.

FIG. 15 illustrates another exemplary set of relationships between metadata group elements and metadata processing states that may arise as metadata group elements are processed by a destination device.

FIG. 16 illustrates a metadata group according to another embodiment of the present disclosure.

FIG. 17 illustrates a metadata group according to a further embodiment of the present disclosure.

### DETAILED DESCRIPTION

Embodiments of the present disclosure provide techniques for efficiently and flexibly representing instances of metadata that may be applied during media coding, decoding, and presentation. According to these embodiments, one or more instances of metadata to be signaled may be represented by a common syntax element, called a “metadata group,” for convenience. Each instance of metadata may be signaled as a metadata header and a metadata payload. The metadata headers may be collected into a common syntax sub-element of the metadata group, called a “header section,” for convenience.

The metadata payloads may provide information that defines the metadata to be applied during media processing. The metadata headers may provide information that determines the scope of the metadata payloads. For example, metadata headers may define an order of priority among the metadata payloads, a persistence of the metadata payloads, and application(s) to which the metadata payloads relate. The metadata payloads of the various instances may be collected into another syntax sub-element of the metadata group, called a “payload section,” again, for convenience. These and other features of the present disclosure are discussed below.

The techniques of the present disclosure overcome limitations of predecessor coding protocols for exchanging metadata between devices. Predecessor protocols commonly provide little or no information in an exchanged bitstream about relationships of metadata units with other metadata units that may exist in the same bitstream. For example, predecessor protocols such as HEVC allow multiple instances of metadata to be communicated in a common SEI NAL unit, but they provide no information about relative priority of metadata units with respect to each other, or information that indicates whether one metadata unit is related to another metadata unit (or a group of metadata units). Although priority/ordering information may not be as important for some types of metadata, e.g., for metadata that just provides some information about the characteristics of a video sequence or a frame, such information can be quite important when metadata relates to processing to be performed on video/frame data. For example, the order of operations could have a considerable impact both on the complexity of the operations performed and the final outcome. Consider, as one example, a video signal that may include one metadata message for performing denoising operations (M0), another for scaling (M1), and a third for adding film grain noise onto the signal (M2). In this scenario, and without any assistive metadata, a decoder would have to determine in which order to process and consider each metadata message. A specific order, e.g., M0->M2->M1, would likely result in a very different outcome compared to a different order, e.g., M2, M0, M1. It is quite likely that a content author may wish to keep this order consistent across most if not all devices. The principles of the present disclosure provide tools to identify order of operations, which can lead to higher quality video output.

The techniques of the present disclosure may overcome other limitations in defining the persistence or scope of the metadata (e.g., does the metadata persist for several frames and if yes for how long does it persist), the ability to detect and extract such metadata easily, especially in applications that involve random access functionalities, clearly associating metadata with specific layers in multi-layer scenarios, and specifying the importance/essentiality of the metadata for a given service of application so such is not inappropriately discarded. With predecessor protocols, destination devices are forced to dig through a bitstream and perform a considerable amount of parsing to determine what metadata types are present in a bitstream, which might be inefficient or cost power on devices. Although attempts have been made in the past to address some of these issues, including the introduction of the manifest and prefix SEI messages in standards such as HEVC and VVC, such solutions only identify information at the sequence level and not at the frame level, and fail to address the situation where multiple SEI messages of the same type may be present for the same frame and may need either for all or for a subset to be considered based on some preconditions.

Embodiments of the present disclosure provide for an efficient representation of metadata units in a coding syntax. In applications where a plurality of metadata units are to be communicated from a source device to a destination device, metadata units may be grouped together for efficient communication. A single metadata unit may be represented in a coding syntax as a metadata header and a metadata payload. The metadata headers may provide information to a destination device that organizes the various metadata units with respect to each other. The metadata payloads may contain metadata information to be applied by a destination device as it performs its media, e.g., video, recovery operations. In an embodiment, efficient representation of metadata units may be provided by grouping them into a metadata group. The metadata group may collect the metadata headers of the various metadata units together into a common syntactic sequence and it further may collect metadata payloads together into a common syntactic sequence. The metadata group may be interleaved in coding data with compressed media to which it relates. The following discussion illustrates various applications of this concept.

The techniques of the present disclosure may provide a design for metadata information that resolves the above issues by better organizing the metadata information and by providing associative information with each metadata. Such information can help both encoders and decoders to better organize and interpret, respectively, the metadata that may be present in a bitstream. In particular, attributes for each metadata unit can now be indicated in the bitstream through a generic metadata header unit that may precede the metadata payload information in a defined metadata group syntax structure, such as a prefix or suffix SEI NAL unit of a particular standard. In an embodiment, such a header may indicate metadata units that are to be signaled in a particular instance (i.e., the metadata group), and this header may define and label properties of each indicated metadata unit. It is expected that such metadata group headers are also easy to parse and can allow decoders to detect and select only the metadata that they support or are appropriate for them and their applications, and can easily skip other metadata that are irrelevant or undesirable. This design not only simplifies the handling of metadata units but also can mitigate potential ambiguities that may arise when distinct metadata units independently define shared concepts.

In an application, a metadata group may precede other metadata units that need to be signaled in a particular instance, e.g., within a prefix or suffix SEI NAL unit of a particular standard, and define and label all the properties of each indicated metadata unit. In this manner, the metadata group becomes easy to parse, which allows decoders to detect and select only the metadata units that they support or are appropriate for them and their applications, and to easily skip other metadata that are irrelevant or undesirable. This design not only simplifies the handling of metadata units but also mitigates potential ambiguities that may arise when distinct metadata units independently define shared concepts.

In many applications, it can be beneficial to encapsulate multiple metadata units into a single group unit that can be signaled or delivered as a whole. In other cases, it may be desirable for the application to only extract metadata that is associated only with one or more group types and discard all others. For example, an application may wish to define a group for which all persisting metadata units associated with it will apply to an entire video sequence. Another group type could be used to signal persisting metadata units that would apply to only a limited range or type of frames (e.g., intra frames or from the 5th until the 15th frame). Such association would enable destination devices to identify all metadata of a specific scope in a more straightforward and potentially simplified manner, and without necessarily parsing the entire stream or in this case the entire metadata group bitstream unit. Benefits may vary based on application. For example, in certain live streaming applications, there may be fewer benefits in using grouping. Grouping, if based on content characteristics, could potentially introduce additional delay, and it may not be as effective. On the other hand, a system may employ historical information or author input to create groups. System designers may weigh the pros and cons of these features when deciding whether or how to apply these principles in their own systems.

As another example of efficient media exchange, a system that encapsulates a compressed media bitstream into a file format (e.g., mp4) may be able to easily identify proper carriage methods for metadata groups. A metadata group that contains metadata payloads that would change infrequently could be carried in an efficient manner e.g., using sample groups of an ISOBMFF format.

Moreover, in other embodiments, metadata units may be interleaved together and the size of each metadata unit may be signaled. When metadata units are quite large (given large payloads), providing such information simplifies parsing of all data units (or at least their headers) to successfully process all metadata units and identify those that are crucial for a specific application.

Systems handling media bitstreams can manage metadata both at the bitstream and system levels. To avoid duplication, metadata present in the bitstream can be removed during packaging/multiplexing, with system-level data structures retaining the necessary information. When needed, the metadata can be restored in the media bitstream or adapted during remultiplexing to other formats.

Metadata may be provided for a variety of purposes in media exchange. For example, metadata may be provided to a destination device that informs the destination device's decision-making when rendering recovered media, removing artifacts from recovered media, adjusting destination device processing resource to be allocated for processing tasks, identifying important content elements from recovered media, and the like. In some applications, metadata may be provided to provide messaging that may be rendered with recovered media, such as context information designated for content elements. The principles of the present disclosure are intended to work cooperatively with all such applications.

Moreover, it is expected that principles of the present disclosure may be employed to carry metadata information as proposed in predecessor inter-operability standards. For example, ITU-T H.265 (HEVC), Annex D describes various types of metadata signaling for video coding. As proposed in HEVC, there is a variety of metadata that could be indicated. Annex D, for example, describes communication of metadata to provide information to a destination device information such as:
a. Frame packing for the indication of a 3D format that may be used for stereoscopic applications;
b. A variety of static or dynamic metadata (such as DolbyVision, HDR10+, color remapping information (CRI), and/or tone curve information);
c. Post filter enhancements;
d. machine learning processing;
e. annotations providing information for media content regions or content objects;
f. Film grain information;
g. Information about upconversion to other formats (e.g., resolutions, frame rates, 4:4:4);
h. Segmentation information;
i. Alpha blending information; and
j. Depth information.
   These and other instances of metadata from Annex D not described hereinabove can be described in metadata provided within improved metadata groups in accordance with the principles of the present disclosure.

FIG. 1 illustrates a media exchange system 100 according to an aspect of the present disclosure. The system 100 may include two or more devices 110, 120 that may exchange media data (such as audio, video, still images, and the like) across a communication network 130. Media data generated at a source device 110 may be compressed according to media coding processes, which reduce the media's bandwidth, and may be transmitted to a destination device 120 for decoding and consumption. In the simplified diagram illustrated in FIG. 1, a source device 110 may send the media to a destination device 120. In other applications, however, the source device 110 may send the media to multiple devices (not shown) in parallel. Moreover, other applications may involve multidirectional exchange of media where, for example, the destination device 120 may generate its own media data, compress it, and send it to the source device 110 for consumption. In further applications, media may be stored at an intermediate device 140, which is provided to a destination device 120 upon request. In another application, the media may be generated and stored on a single device, and consumed on the same device at a later time. The principles of the present discussion find application in all such use cases.

In the example of FIG. 1, the devices 110, 120 are illustrated as tablet computers and smartphones, respectively. The principles of the present disclosure may find applications for a diverse array of device devices, including for example, computer services, personal computers, desktop computers, laptop computers, personal media devices, set top devices, and media players. The type of device is immaterial to the present discussion unless noted otherwise herein.

Real-time exchange of media may cause a source device to compress and transmit media as it is being captured. The principles of the present disclosure find application with non-real time media exchanges, for example, as exchanges that may occur where coded media is stored at a server 140 for retrieval by a destination device.

The principles of the present disclosure may find applications with a wide variety of networks 130. Such networks 130 may include packet-switched and circuit-switched networks, wired and wireless networks, and computer and communications networks. The architecture and topology of the network 130 is immaterial to the present discussion unless noted otherwise herein.

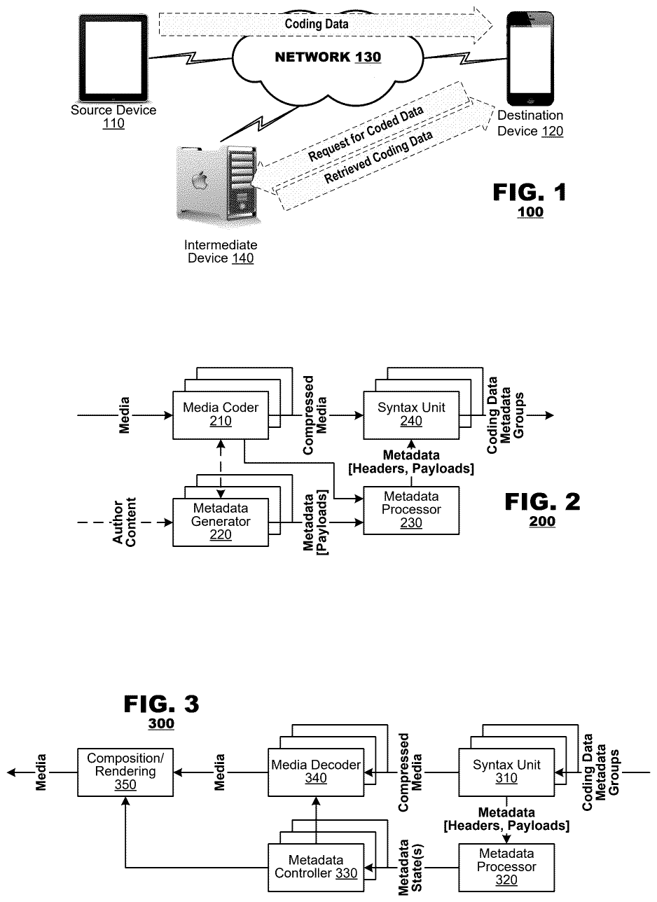

FIG. 2 is a functional block diagram of source device 200 according to an embodiment of the present disclosure. The source device 200 may include a media coder 210, a metadata generator 220, a metadata processor 230, and syntax unit 240. The media coder 210 may apply bandwidth compression operations on input media and may output compressed media to a syntax unit 240. The metadata generator 220 may generate metadata in association with the media, which may be output to the metadata processor 230. The metadata generated by the metadata generator 220 may be represented in metadata payloads when the metadata is provided in coding data. The metadata processor 230 may determine the scopes of the metadata represented by the metadata payloads and may generate information to be provided in metadata headers in association with the metadata payload information received from the metadata generator 220. For example, the metadata processor 230 may determine priority among the different instances of metadata, may determine the persistence of an instance of metadata, and determine other characteristics of these instances as discussed hereinbelow. The syntax unit 240 may develop coding data from the compressed media received from the media coder 210 and the metadata information received from the metadata processor 230; the coding data may conform to a syntax of a coding protocol that governs operation of the source device 200.

The metadata generator 220 may generate metadata from a variety of sources. In a first embodiment, the metadata generator 220 may generate metadata from an analysis of input media or the compressed media that the media coder 210 generates from it. For example, the metadata generator 220 may generate metadata based on an analysis of frame packing, which may be indicated in source media or derived from an analysis of source media. In another example, the metadata generator 220 may generate metadata from an analysis of the compressed media and an estimate of distortion or artifacts created by compression; such analysis may lead to generation of filtering parameters that may reduce such artifacts when employed at a destination device. In yet another example, a media author may provide supplementary content to be displayed at a destination device in association with content elements that exist in the media at predetermined spatial and/or temporal locations; a metadata generator 220 may generate metadata defining such supplementary content and its relationships to the media.

FIG. 2 illustrates functional units of a source device 200 associated with a single media type, for example, video or audio. Additional instances of the media coder 210, metadata generator 220, metadata processor 230, and syntax unit 240 may be provided to accommodate additional types of media.

FIG. 3 is a functional block diagram of a destination device 300 according to an embodiment of the present disclosure. The destination device 300 may include a metadata processor 320, a metadata controller 330, a syntax unit 310, a media decoder 340, and a composition and rendering unit (CRU) 350. The syntax unit 310 may receive coding data and parse it according to the syntactic elements contained within the coding data. It may route elements relating to compressed media to the media decoder 330 and elements relating to metadata groups to the metadata processor 320.

The metadata processor 320 may develop metadata processing state(s) from information contained in the metadata groups and relationships among these instances of metadata. As discussed, the metadata groups may provide information regarding multiple instances of metadata. It is expected that the various instances of metadata will apply to different spans of media. It may occur that some instances of metadata will be active while other instances of metadata are active. It further may occur that some of instances of metadata will not apply to a processing application for which the destination device is being used; in such cases, a given destination device may ignore certain instances of metadata that are inapplicable to its processes. The metadata processor 320 may interpret the metadata group and its different instances of metadata to develop metadata processing state(s) that are relevant to its operation.

The metadata controller 330 may apply the metadata processing state(s) developed by the metadata processor 320. During operation, the media decoder 340 may decode compressed media from the syntax unit 310, and the CRU 350 may perform media composition and rendering operations on the recovered media received from the media decoder 340. The metadata controller 330 may provide control parameters to the media decoder 340 and/or CRU 350 according to the metadata processing states associated with the different portions compressed media that are decoded and rendered.

FIG. 3 illustrates functional units of a destination device 300 associated with a single media type, for example, video or audio. Additional instances of the syntax unit 310, metadata processor 320, metadata controller 330, media decoder 340, and CRU 350 may be provided to accommodate additional types of media.

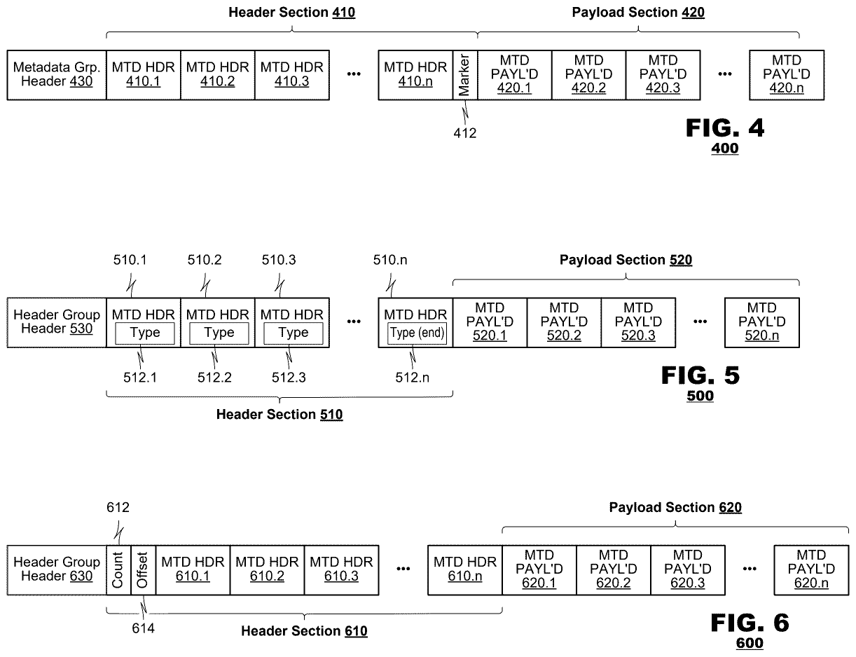

FIG. 4 illustrates a metadata group 400 according to an embodiment of the present disclosure. As discussed, the metadata group 400 may be provided as a syntax element in coding data for exchange of multiple instances of metadata information, where each instance is represented by a metadata header and a metadata payload. Although, in principle, there is no limit to the number of instances of metadata that may be represented in a metadata group 400, the proposed techniques may be used cooperatively with a coding protocol that imposes such limits.

The metadata group 400 may include a header section 410 and a payload section 420. The header section 410 may include the metadata headers 410.1-410.n. The payload section 420 may include the metadata payloads 420.1-420.n. The metadata headers 410.1, 410.2, . . . , 410.n may be provided in a paired relationship with a corresponding metadata payload 420.1, 420.2, . . . , 420.n. The metadata group 400 may include a metadata group header 430, a unique syntax element that identifies the onset of the metadata group 400.

In the embodiment illustrated in FIG. 4, the header section 410 may include a marker 412 that demarcates the end of the header section 410. Thus, when a decoding device interprets the metadata group 400, detection of the end marker 412 may indicate to the device that it has reached the end of the header section 410. In one embodiment, the header section 410 may have a single marker 412 to indicate the terminal end of the header section 410. In another embodiment (not shown), a flag may be provided in each of the metadata headers 410.1-410.n, the state of which may indicate whether a given metadata header 410.1, 410.2, . . . , 410.n is the final metadata header in the header section 410. In the example of FIG. 4, the flag in the final metadata header 410.n would have a state indicating that it is the final metadata header 410.n in the header section 410, and the flags in the other metadata headers 410.1-410.n−1 would have a different state.

In an embodiment, the metadata headers 410.1-410.n may be byte-aligned to facilitate parsing of the metadata headers 410.1-410.n by a destination device.

When the metadata group 400 is interpreted by a destination device, the device may parse the header section 410 into its metadata headers 410.1-410.n. After processing the header section 410, the destination develops information that identifies the locations of the metadata payloads 420.1-420.n in the payload section 420. Oftentimes, it will occur that only a sub-set of the metadata payloads 420.1-420.n will have relevance to the application for which the destination device is using a media stream. In such instances, the destination device may identify and interpret the metadata payloads 420.1-420.n that have relevance to its application without interpreting other metadata payloads that are not relevant.

The following code provides an exemplary process for parsing a header section:

```
metadata_group_unit( ) {
  count = metadata_header_group( );
  payloadOffset = tellg( ); / / get current position
  metadata_payload_group(count);
}
metadata_header_group( ) {
  count = 0
  do {
    end_metadata_flag : f(1);
    if(!end_metadata_flag) {
      metadata_unit_header( count );
      count++;
    }
    byte_alignment( );
  } while( !end_metadata_flag);
  return count;
}
metadata_payload_group(count) {
  for(int i=0; i < count; i++) {
    if(!muh_cancel_flag[ i ]) {
      metadata_unit_payload( muh_payload_size[ i ] );
    }
  }
}
```

In this example, a destination device would determine a number of metadata headers 410.1-410.n based on the state of an end_metadata_flag provided in a coding syntax.

FIG. 5 illustrates a metadata group 500 according to another embodiment of the present disclosure. In this instance, a metadata group 500 includes a header section 510 and a payload section 520. The header section 510 may include an arbitrary number of metadata headers 510.1-510.n perhaps subject to a limit imposed by coding protocol in which the metadata group 500 may be employed. The payload section 520 may include a plurality of metadata payload elements 520.1-520.n in correspondence to the number of metadata headers 510.1-510.n. The metadata headers 510.1, 510.2, . . . , 510.n may be provided in a paired relationship with a corresponding metadata payload 520.1, 520.2, . . . , 520.n. The metadata group 500 may include a metadata group header 530, a unique syntax element that identifies the onset of the metadata group 500.

Each metadata header 510.1, 510.2, . . . , 510.n may include a syntax element 512.1, 512.2, . . . , 512.n identifying its metadata header's type. The metadata header type 512.1, 512.2, . . . , 512.n may include information that indicates whether the respective metadata header 510.1, 510.2, . . . , 510.n is the last metadata header in the metadata group 510. Thus, by interpreting the metadata header type 512.1, 512.2, . . . , 512.n, a destination device may identify the last metadata header 510.n in the metadata group. When a destination device encounters a metadata header type 512.n that indicates the end of the metadata group 510, the destination device may discontinue parsing of the metadata group 510.

In an example, a metadata header type may bet set to a value of 0 to identify a metadata header 510.n as the final one in the header section 510. The code below provides an example for parsing a header section 510 in this example:

```
metadata_header_group( ) {
  count = −1
  do {
    count++;
    metadata_unit_header( count );
    byte_alignment( );
  } while(muh_metadata_type[ count ] != 0);
  return count;
}
```

In this example, the data element muh_metadata_type represents the metadata header type.

FIG. 6 illustrates a metadata group 600 according to a further embodiment of the present disclosure. In this instance, a metadata group 600 includes a header section 610 and a payload section 620. The header section 610 may include an arbitrary number of metadata headers 610.1-610.n perhaps subject to a limit imposed by coding protocol in which the metadata group 600 may be employed. The payload section 620 may include a plurality of metadata payload elements 620.1-620.n in correspondence to the number of metadata headers 610.1-610.n. The metadata headers 610.1, 610.2, . . . , 610.n may be provided in a paired relationship with a corresponding metadata payload 620.1, 620.2, . . . , 620.n. The metadata group 600 may include a metadata group header 630, a unique syntax element that identifies the onset of the metadata group 600.

In the embodiment of FIG. 6, the header section 610 may include syntax elements 612, 614 identifying the number of metadata headers 610.1-610.n (shown as the “count”) and an offset distance from the beginning header section 610 to the payload section 620. The count and offset elements 612, 614 may be provided at a predetermined location of the header section 610 such as its start. A destination device may determine the number of metadata headers 610.1-610.n from the count element 612. The destination may determine the location of the beginning of the payload section 620 from the offset element 614. In embodiments where each metadata payload 620.1, 620.2, . . . , 620.n has a predetermined size, the offset element 614 allows a destination device to determine the locations of the metadata payloads 620.1, 620.2, . . . , 620.n without having to review content of those metadata payloads 620.1, 620.2, . . . , 620.n.

The metadata group configuration of FIG. 6 can lead to processing efficiencies particularly where individual processing applications cause a limited number of the metadata payloads 620.1-620.n to be relevant to a destination device's operation. In this manner, when the destination device has parsed the header section 610 sufficiently to identify the metadata header(s) 610.1-610.n that are relevant to its operation, the destination device may abort further parsing of the header section 610 and identify the metadata payloads 620.1-620.n that correspond to the identified metadata header(s). It is unnecessary for the destination device to review the header section 610 in its entirety.

The code below provides an example for parsing a header section 610 in this example:

```
metadata_group_unit( ) {
  payload_offset : leb128( );
  metadata_unit_cnt : leb128( );
  metadata_header_group( metadata_unit_cnt );
  // payload_offset points to this block
  metadata_payload_group(count);
}
metadata_header_group(count) {
  for(i=0; i< count; i++) {
  metadata_unit_header( i );
  byte_alignment( );
  }
}
metadata_payload_group(count) {
  for(int i=0; i < count; i++) {
    if(!muh_cancel_flag[ i ]) {
      metadata_unit_payload( muh_payload_size[ i ] );
    }
  }
}
```

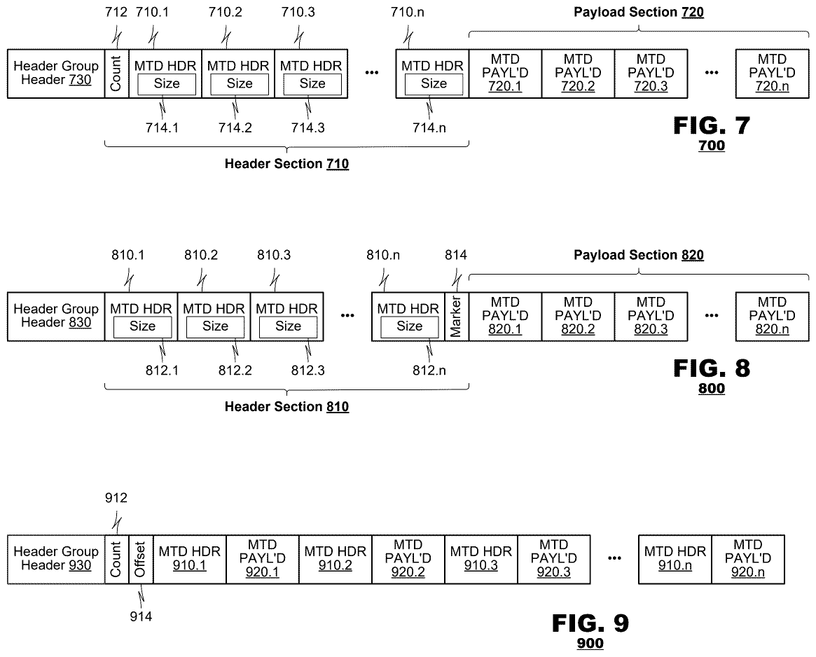

FIG. 7 illustrates a metadata group 700 according to another embodiment of the present disclosure. In this instance, a metadata group 700 includes a header section 710 and a payload section 720. The header section 710 may include an arbitrary number of metadata headers 710.1-710.n perhaps subject to a limit imposed by coding protocol in which the metadata group 700 may be employed. The payload section 720 may include a plurality of metadata payload elements 720.1-720.n in correspondence to the number of metadata headers 710.1-710.n. The metadata headers 710.1, 710.2, . . . , 710.n may be provided in a paired relationship with a corresponding metadata payload 720.1, 720.2, . . . , 720.n. The metadata group 700 may include a metadata group header 730, a unique syntax element that identifies the onset of the metadata group 700.

In an embodiment, the header section 710 may have a count element 712 that identifies the number of metadata headers 710.1-710.n in the header section 710. Each of the metadata headers 710.1, 710.2, . . . , 710.n may possess an element 714.1, 714.2, . . . , 714.n that identifies a size of the respective metadata payloads 720.1, 720.2, . . . , 720.n in the payload section 720.

In this embodiment, a destination device may determine the number of metadata headers 710.1-710.n and payload headers 720.1-720.n from the count element 712. The destination device may determine the locations of the payload headers 710.2-710.n at intermediate locations of the payload section 720 from the size elements 714.1-714.n in the metadata headers 710.1-710.n.

In this embodiment, once a destination device interprets the metadata headers 710.1-710.n of the header section 710 and identifies the metadata headers that are relevant to its application, the destination device may determine the location of the metadata payload(s) from the count element 712 and the size elements 714.1-714.n in the metadata headers 710.1-710.n. In this manner, the destination device can conserve processing resources that otherwise would be consumed by interpreting data from metadata payloads 720.1-720.n that are not relevant to its application to determine the location(s) of the metadata payloads 720.1-720.n that are relevant.

The code below provides an example for parsing a header section 710 in this example:

```
metadata_group_unit( ) {
  metadata_unit_cnt : leb128( );
  for(i = 0; i < metadata_unit_cnt; i++) {
    metadata_unit_header( i );
    metadata_unit_payload( muh_payload_size[ i ] );
  }
  byte_alignment( );
}
```

FIG. 8 illustrates a metadata group 800 according to a further embodiment of the present disclosure. In this instance, a metadata group 800 includes a header section 810 and a payload section 820. The header section 810 may include an arbitrary number of metadata headers 810.1-810.n perhaps subject to a limit imposed by coding protocol in which the metadata group 800 may be employed. The payload section 820 may include a plurality of metadata payloads 820.1-820.n in correspondence to the number of metadata headers 810.1-810.n. The metadata headers 810.1, 810.2, . . . , 810.n may be provided in a paired relationship with a corresponding metadata payload 820.1, 820.2, . . . , 820.n. The metadata group 800 may include a metadata group header 830, a unique syntax element that identifies the onset of the metadata group 800.

In the illustrated embodiment, each of the metadata headers 810.1, 810.2, . . . , 810.n may possess an element 812.1, 812.2, . . . , 812.n that identifies a size of the respective metadata payloads 820.1, 820.2, . . . , 820.n in the payload section 820. The header section 810 also may include a marker 814 that demarcates the end of the header section 810.

In operation, a destination device may parse the header section 810 into its constituent elements, identifying the metadata headers 810.1-810.n within it. When the destination device encounters the marker 814, the destination device may recognize that it has reached the end of the header section 810. For destination devices for which a limited number of the metadata headers 810.1-810.n are relevant, the destination device may identify location(s) of relevant metadata payloads 820.1-820.n from the size elements 812.1, 812.2, etc. of the metadata headers 810.1-810.n. In this manner, the destination device can conserve processing resources that otherwise would be consumed by interpreting data from metadata payloads 820.1-820.n that are not relevant to its application to determine the location(s) of the metadata payloads 820.1-820.n that are relevant.

In other embodiments, metadata groups need not constrain metadata headers into dedicated header sections or constrain metadata payloads to dedicated payload sections. FIG. 9, for example, illustrates a metadata group 900 architecture according to another embodiment of the present disclosure. In this embodiment, a metadata group may contain metadata headers 910.1-910.n and metadata payloads 920.1-920.n provided in an interleaved arrangement, where each metadata payload 920.1, 920.2, . . . , 920.n appears in order immediately following its corresponding metadata header 910.1, 910.2, . . . , 910.n. The metadata group 900 also may include a group header 930, which indicates the appearance of the metadata group 900 in a coding syntax.

The techniques proposed in the foregoing discussion (FIGS. 4-8) may be employed in a metadata group 900 with interleaved metadata headers 910.1-910.n and metadata payloads 920.1-920.n. In the example illustrated in FIG. 9, the metadata headers 910.1-910.n are shown as possessing type elements 912.1-912.n, which may contain data that indicates whether a given metadata header 910.1, 910.2, . . . , or 910.n is the final metadata header in the metadata group 930. In the example of FIG. 9, the type element 912.n of the metadata header 910.n would be set to a value that indicates it is the final metadata header in the metadata group 930.

Interleaved metadata groups may contain count elements, size elements, and other elements that streamline processes performed by destination devices to parse the interleaved metadata groups and read metadata information from metadata payloads 920.1-920.n that are relevant to the devices' respective operations.

The foregoing discussion has presented architectures of metadata groups according to different embodiments of the disclosure. The principles of the present disclosure also allow for supplementation of metadata units over the course of a video session. When a relatively small number of metadata units are to be transmitted as supplemental or revised metadata units, it is not necessary that they be transmitted in metadata groups with their associated signaling overhead. In such case, the supplemental or revised metadata units may be transmitted singly without membership in a metadata group. On the other hand, providing a single instance of a metadata payload in a metadata group may provide benefits in certain scenarios. For example, transmission elements in a data exchange system may drop data elements from coding data that are determined not to be relevant to an exchange session; use of a metadata group can avoid having metadata payload from being dropped in certain circumstances.

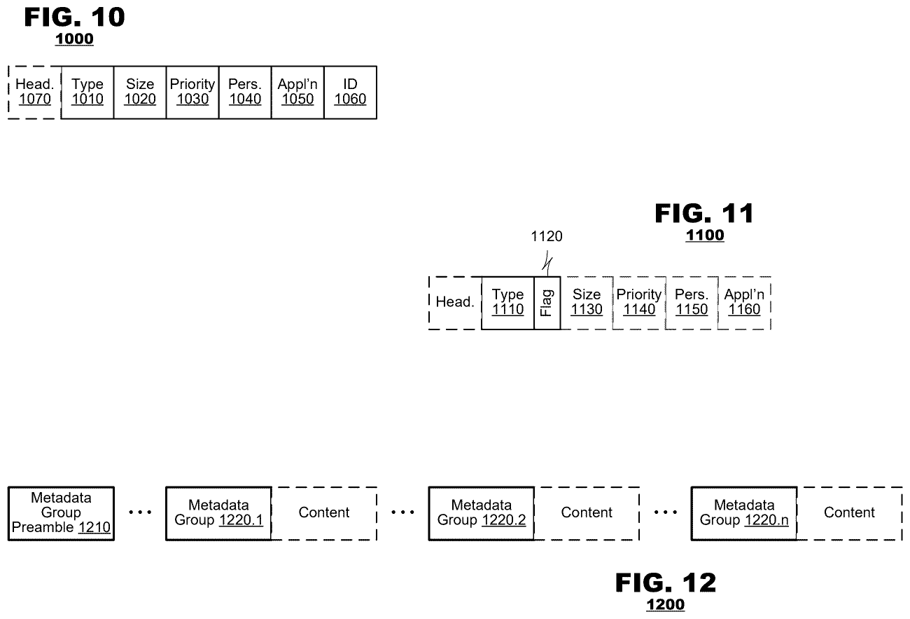

FIG. 10 illustrates data elements that may be included in a metadata header 1000 according to an embodiment of the present disclosure. As discussed with respect to FIG. 5, in some embodiments, the type element 1010 also may contain data that indicate whether the metadata header 1000 is the last metadata header to appear in a header section.

A metadata header 1000 may include a size element 1020 that identifies a size of its corresponding metadata payload and, in the interleaved use case, the size of the associated metadata payload. As discussed, in some embodiments such as those described in FIGS. 7 and 8, a destination device may refer to the size elements of metadata headers to determine the locations of metadata payloads that are relevant to the destination device's processing application without interpreting content of metadata payloads at other locations within a payload section. In embodiments where metadata headers 1000 are not uniformly-sized, the size element 1020 also may provide information defining the size of the metadata header itself. And, in the case of interleaved metadata headers and metadata payloads, the size element may indicate the size of both the metadata header and the metadata payload, which allows a destination device to identify a location of a next metadata header in the metadata group.

A metadata header 1000 may include a priority element 1030 that identifies a priority level to be assigned to its corresponding metadata payload. A destination device may determine, from among the priority levels provided by different metadata headers, relative priorities from among those metadata headers. In this manner, the destination may resolve conflicts that might otherwise arise between metadata payloads that cannot be used cooperatively with other metadata payloads. Moreover, for metadata payloads that result in performance of processing operations that can be used cooperatively with each other, the priority element 1030 may indicate an order in which the processing operations are to be applied by the destination device.

In another embodiment, metadata headers may be provided within a metadata group (FIGS. 4-9) in descending order of priority. In this manner, relative priority among metadata payloads may be defined implicitly by the order in which they appear within a metadata group.

A metadata header 1000 may include a persistence element 1040 that identifies persistence of a corresponding metadata payload. The persistence element 1040, for example, may identify a portion of the corresponding video for which the metadata payload is active. It is common in various coding protocols to define hierarchical constructs to represent video. Different coding protocols, for example, may partition video into video sessions, video sequences, groups of frames (GOPs), frames, fields, slices, tiles, groups of blocks, regions, and the like. The persistence element 1040 may identify a construct (e.g., sequence, GOP, frame) to which its corresponding metadata payload relates. The persistence element 1040 also may provide information that indicates an expiration of the metadata payload, for example, whether a processing state determined by the metadata payload expires with the expiration of its correspondence construct (e.g., its sequence, its GOP, its frame, etc.) or whether the processing state persists with the occurrence of other like-kind constructs (e.g., a later-processed sequence, GOP, or frame with similar characteristics).

A metadata header 1000 may include an element 1050 that identifies an application for which the metadata payload applies. A destination device may determine, from the application element 1050, whether the corresponding metadata payload is relevant to its own processing application. Based on this comparison, the destination device may determine, for example, that the metadata header 1000 is not relevant to its operation and, in such a case, it may cease to devote further resources to interpreting either the metadata header 1000 or its metadata payload (except as may be appropriate to locate other metadata payloads that are relevant).

Consider an example where a video is provided to destination devices that output video to high dynamic range (commonly, HDR) display devices and other destination devices that output video to immersive display devices such as head mounted displays. In such an example, application elements 1050 may be defined to identify metadata payloads that have application to HDR displays (for example, with a first application identifier), to identify metadata payloads that apply to immersive displays (for example, with a second identifier), and to identify metadata payloads that apply to both HDR and immersive displays (a third identifier). In such a manner, a display device may determine, from its own rendering application, which application element identifiers are relevant to its operation.

The relationships between the application element identifiers and the applications to which they relate may be defined in a variety of ways. In one embodiment, the relationships may be defined by a coding protocol by which the destination device operates. For example, it may be defined in a system layer or an application layer of the coding protocol. In another embodiment, the relationships may be defined in a communication sent to the destination device along with the video that the destination device will consume. For example, the relationships may be defined in a supplemental enhancement information (commonly SEI) message provided with video.

In another embodiment, metadata headers may be provided within a metadata group (FIGS. 4-8) grouped together according to the applications for which they are intended. In this manner, two metadata headers that are directed to a common application may appear adjacent to each other within a metadata group. By extension, these metadata headers' metadata payloads also would appear adjacent to each other. When metadata headers and metadata payloads are interleaved (FIG. 9), header-payload pairs may be placed adjacent to each other when directed to a common application. By placing metadata for common applications together in such embodiments, a destination device's task to parse the metadata group may be made easier.

In an embodiment, a metadata header 1000 may include an index 1060 that assigns an identification number to the metadata header 1000 and, by extension, to its metadata payload. Providing an identification number allows for an instance of metadata payload to be revised after it is first defined in a metadata group (e.g., as in FIGS. 4-8). A later-received instance of metadata may identify the metadata payload that is being revised by providing an identification number that matches the index 1060 provided in the earlier-received metadata header 1000.

In another embodiment, an instance of metadata payload may be canceled. A destination device may receive a new instance of metadata with an indication that a certain metadata payload element is to be canceled, such as by providing a cancelation flag along with an identification number that matches the identification number provided in the index 1060.

In another embodiment, an instance of metadata payload may be suspended. A destination device may receive a new instance of metadata with an indication that a certain metadata payload element is to be suspended, such as by providing a suspended flag along with an identification number that matches the identification number provided in the index 1060. The communication that identifies suspension of the previously-received metadata payload may contain data that identifies a duration over which the suspended instance of metadata payload is to be suspended (after which time, the suspended metadata payload may reactivate) or it may indicate that the suspended instance of the metadata payload is to be suspended indefinitely.

In an embodiment where instances of metadata payload may suspend indefinitely, a destination device may receive a new communication that indicates that the suspended metadata payload is to be reactivated. The reactivation communication may include an identification number that matches the identification number provided in the index 1060.

FIG. 11 illustrates a metadata header 1100 according to another embodiment of the present disclosure. In the embodiment illustrated in FIG. 11, the metadata header 1100 may include a type element 1110 and a cancellation flag 1120. As discussed with respect to FIG. 5, in some embodiments, the type element 1110 may contain data that indicates whether the metadata header 1100 is the last metadata header to appear in a header section. In this embodiment, the cancellation flag 1120 may indicate whether a processing state of a corresponding metadata payload is canceled or not. If the cancellation flag 1120 is set to a state that indicates the metadata payload is to be canceled, the metadata header 1120 needs not contain other information following the flag. If the cancellation flag 1120 is set to a state that indicates the metadata payload is to be active, the cancellation flag 1120 may be followed by additional elements in the metadata header 1100.

In the example of FIG. 11, elements representing the metadata header's size 1130, its priority 1140, its persistence 1150, and an application 1160 to which the metadata payload applies may be provided following as cancelation flag 1120. These elements 1130-1160 may provide information as discussed above in connection with the embodiment of FIG. 10.

The following code illustrates the syntax depicted in FIG. 11:

```
metadata_unit_header( p ) {
  muh_metadata_type[ p ] : leb128( );
  muh_cancel_flag[ p ] : f(1);
  if( !muh_cancel_flag[ p ] ) {
    muh_payload_size [ p ] : leb128( );
    muh_priority [ p ] : f(8); // order
    muh_metadata_info[ p ] : f(3);
    muh_layer_idc[ p ] : f(8);
    muh_persistence_idc[ p ] : f(8);
    if( muh_persistence_idc( p ) == PERSISTENCE_MODE_GOP ) {
      muh_persistence_duration [ p ] : leb128( );
    }
    if( muh_layer idc( p ) != LAYER_MODE_GLOBAL ) {
      layer_info( p, muh_layer_idc[ p ] );
    }
  }
}
```

In an alternative embodiment, where persistence is not applied, the syntax may be defined as follows:

```
metadata_unit_header( p ) {
  muh_metadata_type[ p ] : leb128( );
  muh_has_persistence_info_flag[ p ] : f(1);
  if(muh_has_persistence_info_flag)
    muh_cancel_flag[ p ] : f(1);
  else
    muh_cancel_flag[ p ] = 0
  if( !muh_cancel_flag[ p ] ) {
    muh_payload_size[ p ] : leb128( );
    muh_priority[ p ] : f(8); // order
    muh_metadata_info[ p ] : f(3);
    muh_layer_idc[ p ] : f(8);
    if(muh_has_persistence_info_flag) {
      muh_persistence_idc[ p ] : f(8);
      if( muh_persistence_idc( p ) == PERSISTENCE_MODE_GOP ) {
        muh_persistence_duration[ p ] : leb128( );
      }
    }
    if( muh_layer_idc( p ) != LAYER_MODE_GLOBAL ) {
      layer_info( p, muh_layer_idc[ p ] );
    }
  }
}
```

In a further embodiment, it may be advantageous to employ a syntax that flexibly indicates what information about the metadata is present in the coded data. A syntax as shown below may find application in such an embodiment:

```
metadata_unit_header( p ) {
  muh_metadata_type[ p ] : leb128( );
  muh_has_persistence_info_flag[ p ] : f(1);
  if(muh_has_persistence_info_flag)
    muh_cancel_flag[ p ] : f(1);
  else
    muh_cancel_flag[ p ] = 0
    muh_reserved_1bit : f(1);
  }
  if( !muh_cancel_flag[ p ] ) {
    muh_priority_present_flag[ p ] f(1)
    muh_metadata_info_present_flag[ p ] f(1)
    muh_layer_idc_present_flag[ p ] f(1)
    muh_reserved_3bits[ p ] f(3)
    muh_payload_size[ p ] : leb128( );
    if(muh_priority_present_flag[ p ] )
      muh_priority[ p ] : f(8); // order
    if(muh_layer_idc_present_flag[ p ])
      muh_metadata_info[ p ] : f(3);
    if(muh_layer_idc_present_flag[ p ] )
      muh_layer_idc[ p ] : f(8);
    else
      muh_layer_idc[ p ] = LAYER_MODE_UNSPECIFIED
    if(muh_has_persistence_info_flag) {
      muh_persistence_idc[ p ] : f(8);
      if( muh_persistence_idc( p ) == PERSISTENCE_MODE_GOP ) {
        muh_persistence_duration[ p ] : leb128( );
      }
    }
    / / The conditional below is an alternative of what is used
    / / if( muh_layer_idc( p ) > LAYER_MODE_CURRENT ) {
    if( muh_layer_idc( p ) != LAYER_MODE_UNSPECIFIED & &
      muh_layer_idc( p ) != LAYER_MODE_GLOBAL && muh_layer_idc( p )
      != LAYER_MODE_CURRENT ) {
      layer_info( p, muh_layer_idc[ p ] );
    }
  }
}
```

A further example is provided below, which employs an exemplary application identifier:

```
metadata_unit_header( p ) {
  muh_metadata_type[ p ] : leb128( );
  muh_has_persistence_info_flag[ p ] : f(1);
  if(muh_has_persistence_info_flag)
    muh_cancel_flag[ p ] : f(1);
  else {
    muh_cancel_flag[ p ] = 0
  muh_reserved_1bit : f(1);
  }
  if( !muh_cancel_flag[ p ] ) {
    muh_application_present_flag[ p ] f(1)
    muh_priority_present_flag[ p ] f(1)
    muh_metadata_info_present_flag[ p ] f(1)
    muh_layer_idc_present_flag[ p ] f(1)
    muh_reserved_2bits[ p ] f(2)
    muh_payload_size[ p ] : leb128( );
    if(muh_application_present_flag[ p ] )
      muh_application_id[ p ] : f(8); // Application scope id of
message indicated(e.g. id could indicate that this relates to HDR)
    if(muh_priority_present_flag[ p ] )
      muh_priority[ p ] : f(8); // order
    if(muh_layer_idc_present_flag[ p ] )
      muh_metadata_info[ p ] : f(3);
    if(muh_layer idc present flag[ p ] )
      muh_layer_idc[ p ] : f(8);
    else
      muh_layer_idc[ p ] = LAYER_MODE_UNSPECIFIED
    if(muh_has_persistence_info_flag) {
      muh_persistence_idc[ p ] : f(8);
      if( muh_persistence_idc( p ) == PERSISTENCE_MODE_GOP ) {
        muh_persistence_duration[ p ] : leb128( );
      }
    }
    / / The conditional below is an alternative of what is used
    / / if( muh_layer_idc( p ) > LAYER_MODE_CURRENT ) {
    if( muh_layer_idc( p ) != LAYER_MODE_UNSPECIFIED
    & & muh_layer_idc( p ) != LAYER_MODE_GLOBAL
    & & muh_layer_idc( p ) != LAYER_MODE_CURRENT ) {
    layer_info( p, muh_layer_idc[ p ] );
    }
  }
}
```

An exemplary syntax for layer information may occur as follows:

```
layer_info( p, mode ) {
  if(mode == LAYER_MODE_VALUES ) {
    li_layer_cnt[ p ] : f(8);
    for(for i = 0; i < li_layer_cnt[ p ]; i++) {
      li_layer_id[ i ] : f(8);
    }
  } else if(mode == LAYER_MODE_RANGE) {
    li_min_layer[ p ] : f(8);
    li_max_layer[ p ] : f(8);
  else if(mode == LAYER_MODE_MAX) {
    li_max_layer[ p ] : f(8); // from the current layer up to this
  }
}
```

In the foregoing discussion, syntax elements may have the following semantics:

muh_metadata_type[p] may signal the type of the metadata unit with index p.

muh_has_persistence_info_flag[p] may indicate whether the metadata unit with index p has any persistence scope information indicated in the bitstream or whether this is omitted. When muh_has_persistence_info_flag[p] is equal to 0, no persistence scope information is indicated with metadata unit with index p. Persistence may be determined through either the type of the metadata or the application. If, for example the metadata is indicated to be static, this information may persist until a new metadata of the same type is indicated. If dynamic, then the metadata may be only considered for one frame and the information does not persist for any subsequent frames. When muh_has_persistence_info_flag[p] is equal to 1, additional information may be present in the bitstream that indicates such persistence information muh_cancel_flag[p] when set to 1, it indicates that any previously signaled metadata information for a metadata with type equal to muh_metadata_type[p] is cancelled. Additionally, the payload size of the current metadata unit is set to 0. When set to 0, it signifies that the metadata of a type equal to muh_metadata_type[p] is signaled in the current metadata unit. In this case, additional information will be signaled as part of the metadata header.

muh_application_present_flag[p] may enable the presence of the application information for the current message.

muh_priority_present_flag[p] may enable the presence of the priority information for the current message.

muh_metadata_info_present_flag[p] may enable the presence of the metadata information for the current message.

muh_layer_idc_present_flag[p] may enable the presence of the layer idc applicability information for the current message.

muh_application_id[p] may indicate the application id associated with the current message. This application id could be predefined or defined through external means.

muh_payload_size[p] may signal the size of the metadata payload in bytes.

muh_priority[p] may be used to indicate the relative importance or urgency of a particular type of metadata. A lower value indicates a higher priority, while a higher value indicates a lower priority. This information can be used by decoders to prioritize the processing of different types of metadata, ensuring that critical or time-sensitive metadata is handled before less important metadata. Furthermore, it can also be beneficial on a system level. For example, in lossy channels, more important information can be protected or re-transmitted more frequently, ensuring that critical or time-sensitive metadata is less likely to be lost or corrupted during transmission.

muh_metadata_info[p] may specify the information type of the p-th metadata unit, for example, as follows:

| | Name of | |
|---|---|---|
| muh_metadata_info[ i ] | muh_metadata_info[ i ] | Description |
| 0 | UNDETERMINED | The necessity of the current |
| | | metadata unit is |
| | | undetermined. |
| 1 | NECESSARY | This metadata unit should be |
| | | considered as necessary. |
| 2 | UNNECESSARY | This metadata unit should be |
| | | considered as unnecessary. |
| 3 | As defined in | This metadata unit should |
| | a manifest SEI | take importance according to |
| | message | what is specified in a |
| | | manifest (or equivalent) SEI |
| | | message, if present. |
| 4-7 | Reserved | Reserved |

muh_layer_idc[p] may signal a mode that specifies the layers to which the signaled metadata applies. This value can represent different modes, such as applying the metadata to all layers, applying the metadata to a continuous range of layer values, or applying the metadata to a set of specific layer values. Exemplary values for the layer_idc may be defined as follows:

| muh_layer_idc[ p ] | Name of muh_layer_idc[ p ] | Description |
|---|---|---|
| 0 | LAYER_MODE_UNSPECIFIED | The current signaling does not |
| | | specify to what layers the |
| | | metadata applies to. This |
| | | information can potentially be |
| | | indicated or determined through |
| | | external means. |
| 1 | LAYER_MODE_GLOBAL | The metadata applies to all layers. |
| 2 | LAYER_MODE_CURRENT | The metadata applies to the |
| | | current layer only (as indicated |
| | | by the OBU header) |
| 3 | LAYER_MODE_RANGE | The metadata applies to a |
| | | continuous range of layer values, |
| | | which are explicitly signaled. |
| 4 | LAYER_MODE_VALUES | The metadata applies to a set of |
| | | specific layer values, which are |
| | | explicitly signaled. |
| 5 | LAYER_MODE_MAX | The metadata applies to a |
| | | continuous range of layer values |
| | | starting from the current layer |
| | | until the explicitly signaled |
| | | maximum value. |
| 6-255 | Reserved | Reserved |

muh__persistence_idc[p] may be used to signal the mode in which the signaled metadata persists over time. This value can represent different modes, such as global persistence for the entire video sequence, persistence for a group of frames of a certain duration, or persistence for a single frame only. Exemplary values for the muh_persistence_idc may be defined as follows:

| muh_persistence_{—} | Name of | |
|---|---|---|
| idc[ p ] | muh_persistence_idc[ p ] | Description |
| 0 | PERSISTENCE_GLOBAL | Global persistence for the entire video |
| | | sequence. When this mode is |
| | | signaled, previously signaled global |
| | | metadata of this type are overwritten. |
| 1 | PERSISTENCE_LOCAL_GOP | Persistence for a group of frames. |
| 2 | NO_PERSISTENCE | Only used for the current frame. |
| 3-255 | Reserved | Reserved |

muh_persistence_duration[p] when the persistence mode is signaled to indicate that the metadata persists across multiple frames, the value of this field may signal the number of consecutive frames that the metadata will apply to, starting with the temporal unit where this metadata unit is present.

In this embodiment, when muh_cancel_flag[p] is set to 1, the metadata may be canceled immediately, regardless of the values of muh_persistence_idc[p] and muh_persistence_duration[p].

The following provides an exemplary method of interpreting syntax elements for canceling metadata units:

```
metadata_unit_header( p ) {
  muh_metadata_type[ p ] : leb128( );
  muh_cancel_flag[ p ] : f(1);
  muh_persistence_idc[ p ] : f(8);
  muh_layer_idc[ p ] : f(8);
  if( !muh_cancel_flag[ p ] ) {
    muh_payload_size[ p ] : leb128( );
    muh_priority[ p ] : f(8); / / order
    muh_metadata_info[ p ] : f(3);
    if( muh_persistence_idc( p ) == PERSISTENCE_MODE_GOP ) {
      muh_persistence_duration[ p ] : leb128( );
    }
  }
  if( muh_layer_idc( p ) != LAYER_MODE_GLOBAL ) {
    layer_info( p, muh_layer_idc[ p ] );
  }
}
```

In the foregoing embodiments, a metadata group header (FIGS. 4-9) may be provided periodically within a media stream, such as for every frame of video. In other embodiments, bandwidth conservation may occur by utilizing a preamble metadata header that provides metadata header information that may apply to multiple metadata group headers. The preamble metadata header need not be associated with any single unit of media but, instead, may precede the media units to which it applies and, by extension, the metadata group headers.

FIG. 12 illustrates a coding syntax according to an embodiment of the present disclosure. In this embodiment, a coded data stream 1200 may include a metadata group preamble 1210 and one or more metadata groups 1220.1-1220.n. The metadata group preamble 1210 may precede the metadata groups 1220.1-1220.n to which it relates. Each metadata group 1220.1, 1220.2, . . . , 1220.n may be interleaved with coded content to which it relates.

As discussed, the metadata group preamble 1210 may provide information that otherwise would be provided in metadata headers (see FIGS. 4-9) of the metadata units. For example, information such as priority, persistence, usage, etc. may be provided in the metadata group preamble 1210, which would define properties that apply to the metadata headers of the metadata groups 1220.1-1220.n to which it relates. In an embodiment, a metadata group preamble 1210 may be associated not only with metadata groups 1220.1-1220.n but also may have an identifier that identifies an application to which the metadata group preamble 1210 will apply. In this manner, it is permissible to define a plurality of metadata group preambles 1210 (not shown), each distinguished by their application id, that can be simultaneously active. Thus, during operation, if a destination device encounters a metadata group payload X, and the indication that this is to be used with application id Y, then the destination resolves the metadata group's properties with respect to a metadata preamble that is associated with the application id Y.

Further, a metadata group preamble 1210 can be indicated a first time in coded media (for example, at the start of a bitstream), and it can be indicated again in the bitstream at a later point, if desired, to overwrite/replace or augment/update a previous similar metadata group preamble 1210.

In an implementation that employs metadata group preambles, metadata groups 1220.1-1220.n may be provided with reduced-bit representations. For metadata groups 1220.1-1220.n that inherit properties that are defined in a metadata group preamble, it becomes unnecessary to signal those properties expressly in the metadata headers of those groups. In one embodiment, the properties that a metadata header inherits from a metadata group preamble may be skipped. For example, a metadata group preamble may have defined priority and persistence information. In those metadata groups 1220.1-1220.n that inherit the priority and persistence information, the metadata headers may skip priority and persistence information, which saves bits in the coding data. The metadata payloads associated with those metadata headers (FIGS. 4-9) would be provided in the coding data 1200 to provide the metadata that will be used by the destination device.

In another embodiment, rather than skipping, in a metadata header, properties that are inherited from a metadata group preamble, a metadata header may include flags that indicate which properties are provided expressly in the metadata header and which properties are provided elsewhere in the coding syntax. When a flag is set to a first value (say, 1), it may indicate to a destination device that a respective property is to be found elsewhere in the coding data, such as a metadata group preamble 1210. When a flag is set to a different value, it may indicate that the property information is provided locally within the metadata header. In this embodiment, the syntax parsing may be kept independent, but the embodiment provides an opportunity to override the metadata properties indicated in the metadata group preamble 1210 as desired. This embodiment also may lead to bits savings through use of metadata group preambles.

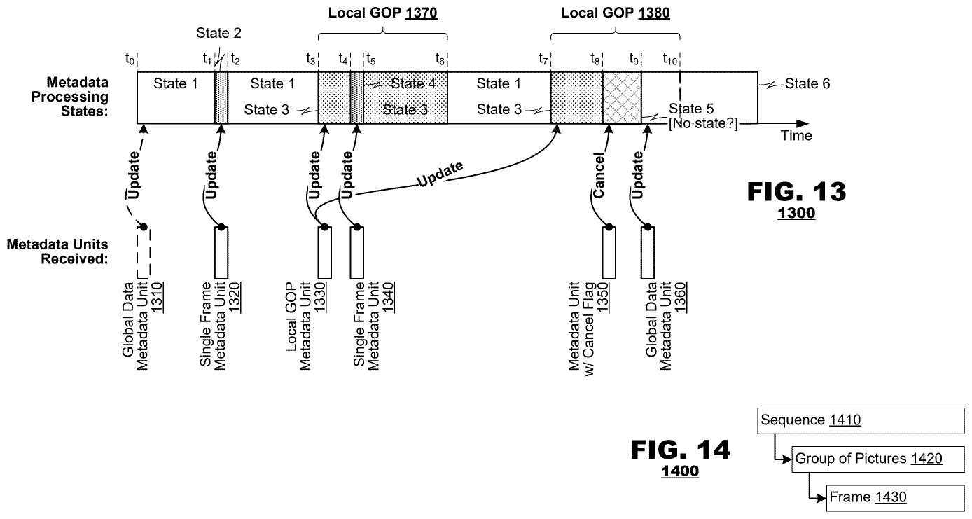

FIG. 13 illustrates an exemplary set of relationships between metadata group elements and metadata processing states that may arise as metadata group elements are processed by a destination device. In this example, a destination device receives metadata units 1310-1360 that apply to different instances of coded video. For example, a first metadata unit 1310, 1360 may apply to video sequences, another metadata unit 1330 may apply to a group of pictures (GOP), other metadata units 1320, 1340 may apply to individual frames. The example of FIG. 13 also illustrates a metadata unit that includes a cancel flag 1350.

The metadata units 1310-1360 may be defined within the context of a coding protocol that governs operation of a destination device that processes the metadata units 1310-1360. FIG. 14 illustrates a simplified hierarchy 1400 in which the metadata units 1310-1360 may be processed. As illustrated in FIG. 14, a video sequence 1410 may include one or more groups of pictures 1420, and groups of pictures 1320 may include one or more frames 1430. Of course, the hierarchy illustrated in FIG. 14 is only exemplary; in practice, coding protocols may employ other elements and different numbers of hierarchical elements than those that are illustrated. The principles of the present disclosure find application with other coding protocol hierarchies.

The metadata units 1310-1360 may define a plurality of metadata processing states in a destination device. For example, a global data metadata unit 1310 may define a processing state across a video sequence, starting at time to. In FIG. 13, the processing state is illustrated as State 1.

A second metadata unit 1320 may define metadata to be applied to a single frame at time t₁, either as a replacement for the metadata defined in the global metadata unit 1310 or as metadata to be applied in concert with the metadata defined in the global metadata unit 1310. In either event, the metadata provided in the second metadata unit 1320 may institute a second processing state at the destination device, shown as State 2. Because it persists for a single frame, State 2 may expire at time t₂, the expiration of the frame to which it applies. After time t₂, the processing state may revert back to State 1, since the global data metadata unit 1310 applies to the video sequence extending between times t₂ and t₃.

A third metadata unit 1330 may define metadata to be applied to a GOP 1370, shown as extending from time t₃ to t₅. Here, again, the metadata unit 1330 may define metadata that either replaces the metadata defined in the global metadata unit 1310 or is to be applied cooperatively with the metadata defined in the global metadata unit 1310. In either instance, the third metadata unit 1330 may cause the destination device to develop another processing state, shown as State 3. The third processing state (State 3) may persist until the GOP 1370 expires or until it is interrupted by metadata of another metadata unit. In the example illustrated in FIG. 13, the third metadata unit 1330 may define metadata may persist not only for a GOP 1370 to be processed in the span from times t₃ to t₆ but also for the span(s) of other similar GOPs 1380. FIG. 13 illustrates similar GOP 1380, extending from times t₇ to t₁₀, to which the metadata unit 1330 applies.

In the example of FIG. 13, the processing State 3 is interrupted by another single frame metadata unit 1340. The metadata unit 1340 may cause the destination device to develop another processing state (State 4), which persists for the duration of the frame to which it applies. In the example of FIG. 13, State 4 is shown in the span from time t₄ to t₅, and the destination device is shown returning to State 3 during the span from t₅ to t₆ when the GOP 1370 expires.

At time t₆, FIG. 13 illustrates the processing state returning to State 1 due to the expiration of the GOP 1370. FIG. 13 illustrates the destination device's processing state returning to State 3 at time t₇ due to the presence of the GOP 1380.

FIG. 13 illustrates a metadata unit 1350 with a cancellation flag set corresponding to video at time t₈. In response to the cancellation flag, the destination device may cancel all preceding states, including the state (State 1) that is set by the previously-received global metadata unit 1300. Thus, the destination device operates with no processing state until another metadata unit is processed. FIG. 13 illustrates another metadata unit 1360, effective at time t₉, which would cause the destination device to enter a new processing state (State 6).

In this example, although the GOP 1380 does not expire until time t₁₀, the metadata unit 1350 with the cancellation flag may cause the state that otherwise would be developed from the metadata unit 1330 to be canceled. The presence of a new metadata unit 1360 that relates to video starting at time t₉ causes the new state (State 6) to be instantiated, in this embodiment.

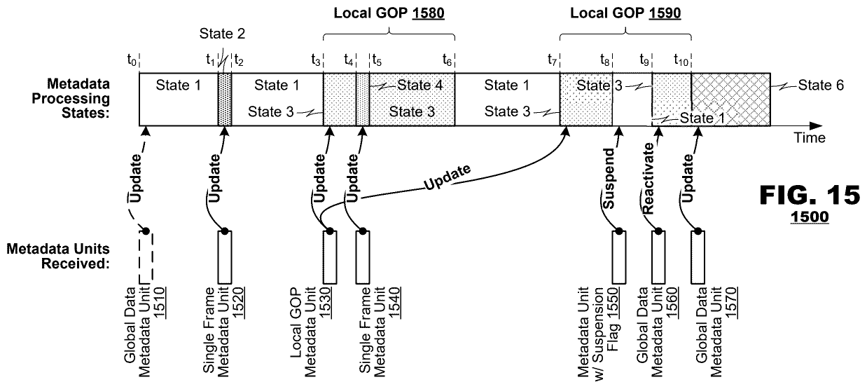

FIG. 15 illustrates an exemplary set of relationships between metadata group elements and metadata processing states that may arise as metadata group elements are processed by a destination device. In this example, a destination device receives metadata units 1510-1570 that apply to different instances of coded video. For example, a first metadata unit 1510, 1560 may apply to video sequences, another metadata unit 1530 may apply to a group of pictures, other metadata units 1520, 1540 may apply to individual frames. The example of FIG. 15 also illustrates a metadata unit 1550 that includes a suspension flag and another metadata unit 1560 that indicates that a prior suspension has been lifted.

As in the example of FIG. 15, the metadata units 1510-1560 may be defined within the context of a coding protocol that governs operation of a destination device that processes the metadata units 1510-1560 such as the hierarchy illustrated in FIG. 14. Again, the hierarchy illustrated in FIG. 14 is only exemplary; in practice, coding protocols may employ other elements and different numbers of hierarchical elements than those that are illustrated. The principles of the present disclosure find application with other coding protocol hierarchies.

The metadata units 1510-1560 may define a plurality of metadata processing states in a destination device. For example, a global data metadata unit 1510 may define a processing state across a video sequence, starting at time to. In FIG. 15, the processing state is illustrated as State 1.

A second metadata unit 1520 may define metadata to be applied to a single frame at time t₁, either as a replacement for the metadata defined in the global metadata unit 1510 or as metadata to be applied in concert with the metadata defined in the global metadata unit 1510. In either event, the metadata provided in the second metadata unit 1520 may institute a second processing state at the destination device, shown as State 2. Because it persists for a single frame, State 2 may expire at time t₂, the expiration of the frame to which it applies. After time t₂, the processing state may revert back to State 1, since the global data metadata unit 1510 applies to the video sequence extending between times t₂ and t₃.

A third metadata unit 1530 may define metadata to be applied to a GOP 1580, shown as extending from time t₃ to t₅. Here, again, the metadata unit 1530 may define metadata that either replaces the metadata defined in the global metadata unit 1510 or is to be applied cooperatively with the metadata defined in the global metadata unit 1510. In either instance, the third metadata unit 1530 may cause the destination device to develop another processing state, shown as State 3. The third processing state (State 3) may persist until the GOP 1580 expires or until it is interrupted by metadata of another metadata unit. In the example illustrated in FIG. 15, the third metadata unit 1530 may define metadata may persist not only for a GOP 1580 to be processed in the span from times t₃ to t₆ but also for the span(s) of other similar GOPs 1590. FIG. 15 illustrates a similar GOP 1590, extending from times t₇ to t₁₀, to which the metadata unit 1530 applies.

In the example of FIG. 15, the processing State 3 is interrupted by another single frame metadata unit 1540. The metadata unit 1540 may cause the destination device to develop another processing state (State 4), which persists for the duration of the frame to which it applies. In the example of FIG. 15, State 4 is shown in the span from time t₄ to t₅, and the destination device is shown returning to State 3 during the span from t₅ to t₆ when the GOP 1580 expires.

At time t₆, FIG. 15 illustrates the processing state returning to State 1 due to the expiration of the GOP 1570. FIG. 15 illustrates the destination device's processing state returning to State 3 at time t₇ due to the presence of the GOP 1590.

FIG. 15 illustrates a metadata unit 1550 with a suspension flag set corresponding to video at time t₈. In an embodiment, suspension flags may contain identifiers that designate specific metadata units that are to be suspended; in the example illustrated in FIG. 15, the suspension metadata unit 1560 may identify the metadata unit 1530 as subject to suspension. Thus, FIG. 15 shows that the destination device returns to State 1 in response to the metadata unit 1560.

The next metadata unit 1560 in the example of FIG. 15 may indicate that a prior metadata unit is to be reactivated. In this example, the reactivation pertains to metadata unit 1530. Thus, FIG. 15 illustrates that the destination device reenters State 3 at time t₉ to which the metadata unit 1560 relates.

FIG. 15 illustrates another metadata unit 1570, effective at time t₁₀, which sets a new set of metadata for a new video sequence. The metadata unit 1570 would cause the destination device to enter a new processing state (State 6).

The following provides an exemplary method of interpreting syntax elements for activating metadata units:

```
metadata_unit_header( p ) {
  muh_metadata_type[ p ] : leb128( );
  muh_cancel_flag[ p ] : f(1);
  if( !muh_cancel_flag[ p ] ) {
    muh_activate_existing_flag[ p ] : f(1);
    if(muh_activate_existing_flag[ p ] )
      muh_activated_id[ p ] : f(8); // optional
    else {
      muh_current_id[ p ] : f(8); // optional
      muh_is_activated flag[ p ] : f(1);
      muh_payload_size[ p ] : leb128( );
      muh_priority[ p ] : f(8); // order
      muh_persistence_idc[ p ] : f(8);
      muh_metadata_info[ p ] : f(
      muh
      layer_idc[ p ] : f(8);
      if( muh_persistence_idc( p ) == PERSISTENCE_MODE_GOP) {
        muh_persistence_duration[ p ] : leb128( );
      }
      if( muh_layer_idc( p ) != LAYER_MODE_GLOBAL ) {
        layer_info( p, muh_layer_idc[ p ] );
      }
    }
  }
}
```

The following provides an exemplary method for assigning levels of metadata units which may signal to a destination device how metadata overrides are to be applied:

```
metadata_unit_header( p ) {
  muh_metadata_type[ p ] : leb128( );
  muh_level_idc[ p ] : f(2);
  muh_cancel_flag[ p ] : f(1);
  if( !muh_cancel_flag[ p ] ) {
    muh_payload_size[ p ] : leb128( );
    muh_level_id[ p ] : f(8);
    muh_priority[ p ] : f(8); / / order
    muh_persistence_idc[ p ] : f(8);
    muh_metadata_info[ p ] : f(3);
    muh_layer_idc[ p ] : f(8);
    if( muh_persistence_idc( p ) == PERSISTENCE_MODE_GOP) {
      muh_persistence_duration[ p ] : leb128( );
    }
    if( muh_layer_idc( p ) != LAYER_MODE_GLOBAL ) {
      layer_info( p, muh_layer_idc[ p ] );
    }
  }
}
```

In the foregoing example, the value muh_level_idc may signal how different levels are to be interpreted. For example, muh_level_idc may have assignments such as:

| muh_level_idc value | Meaning |
|---|---|
| 0 | global |
| 1 | overrides level 0 until level 1 is cancelled |
| 2 | overrides levels lower than 2 until level 2 is cancelled |
| . . . | |
| N − 1 | Disables the metadata while keeping the payload untouched |

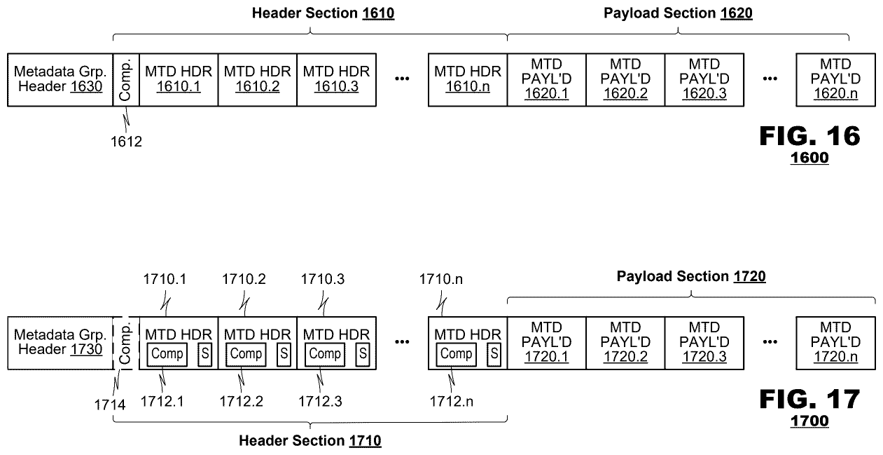

In another embodiment, compression may be applied to payload sections of metadata groups to reduce their representations in coded bitstreams. FIG. 16 illustrates a metadata group 1600 according to an embodiment that employs compression. There, a metadata group 1600 is shown including a header section 1610, a payload section 1620, and a metadata group header 1630. As in other embodiments, the header section 1610 may include a plurality of metadata headers 1610.1, 1610.2, . . . , 1610.n provided in correspondence with metadata payloads 1620.1, 1620.2, . . . , 1620.n from the payload section 1620. In this embodiment, the payloads 1620.1, 1620.2, . . . , 1620.n may be compressed according to compression information 1612 provided in the header section 1610.

In the embodiment of FIG. 16, the compression information 1612 may indicate whether the payload section 1620 has been compressed and, if so, parameters of the compression that was applied such as a compression algorithm that was applied (e.g., whether deflate, broth, or another compression algorithm was applied). In a simple embodiment, a compression flag may indicate whether compression is applied; for example, a state of 0 may indicate that no compression is applied, and a state of 1 may indicate that compression is applied. When identification of the compression algorithm is determined from other sources, for example, it is defined by a coding protocol to which the source and destination devices adhere or it is derived from other syntactic elements (not shown), it may not be necessary to identify the compression algorithm in the compression information 1612. In other cases, the compression information 1612 may identify a compression algorithm either expressly or impliedly. For example, the compression information 1612 has state data (e.g., state 2) indicating that compression is used and identifying a compression algorithm that is applied (e.g., whether deflate, broth, or other compression algorithm(s) were applied), and it may have other state data (e.g., state 1) indicating that compression is used and that the compression algorithm has not changed from a prior instance of compression information (not shown). The semantics and syntax of compression information 1612 may be tailored to suit individual implementation needs.

This embodiment of FIG. 16 permits metadata payloads 1620.1, 1620.2, . . . , 1620.n to be compressed, which may reduce consumption of transmission resources when the metadata payloads 1620.1, 1620.2, . . . , 1620.n are transmitted in a media exchange system (FIG. 1). In some coding applications, there can be instances where metadata information can be hundreds or even thousands of bytes and, depending on the coding application that is used, the metadata information can be present in every frame. ICC profiles, for example, can have instances of metadata that are over 10 k bytes. Thus, applying compression to instances of metadata payloads 1620.1, 1620.2, . . . , 1620.n can achieve significant resource savings in media exchange systems.

FIG. 17 illustrates a metadata group 1700 according to another embodiment of the present disclosure. The metadata group 1700 may include a header section 1710, a payload section 1720, and a metadata group header 1730. And, as before, the header section 1710 may include a plurality of metadata headers 1710.1, 1710.2, . . . , 1710.n provided in correspondence with metadata payloads 1720.1, 1720.2, . . . , 1720.n from the payload section 1720. In this embodiment, the payload section 1720 may be compressed according to compression information provided in the header section 1710.

In an embodiment, compression information 1712.1, 1712.2, . . . , 1712.n may be provided in each of the metadata headers 1710.1, 1710.2, . . . , 1710.n. In this embodiment, each instance of compression information 1712.1, 1712.2, . . . , 1712.n may indicate whether an associated metadata payload 1720.1, 1720.2, . . . , 1720.n has been compressed. In a simple embodiment, each instance of compression information 1712.1, 1712.2, . . . , 1712.n may be a flag that indicates whether compression is applied; for example, a state of 0 may indicate that no compression is applied, and a state of 1 may indicate that compression is applied. Again, the type of compression may be derived from other sources, which allows use of a single bit flag. Alternatively the compression information 1712.1, 1712.2, . . . , 1712.n may have one state (e.g., state 2) to indicate that compression is used and to identify a compression algorithm that is applied (e.g., whether deflate, broti, or other compression algorithm(s) were applied) and another state (e.g., state 1) to indicate that compression is used and to indicate that a default compression algorithm is applied. Here, again, the semantics and syntax of compression information 1712.1, 1712.2, . . . , 1712.n may be tailored to suit individual implementation needs. In another embodiment the compression information of one metadata payload may be predicted from the compression information of the immediately previous metadata payload.

In an embodiment, the sizes of individual metadata payloads 1720.1, 1720.2, . . . , 1720.n will be available to a source device at the time a metadata group 1700 is being created in which case a source device may include size information within metadata payloads 1720.1, 1720.2, . . . , 1720.n. This allowed a destination device to locate a metadata payload 1720.1, 1720.2, . . . , 1720.n of interest for decompression and consumption.

This embodiment permits payload sections 1720 to be compressed, which may reduce consumption of transmission resources when the payload section 1720 is transmitted in a media exchange system. For coding applications where metadata information can be hundreds of bytes, thousands of bytes, or more, applying compression to payload sections 1720 can achieve significant resource savings.

In another embodiment, also illustrated in FIG. 17, compression information may be distributed across a header section 1710 of a metadata group 1700. A first instance of compression information 1714 may provide global information regarding compression that applies to the entirety of the payload section 1720. For example, the group-wide compression information 1714 may include state information indicating whether compression has been applied to any metadata payload 1720.1, 1720.2, . . . , or 1720.n in the payload section. The group-wide compression information 1714 also may include information identifying a default compression algorithm for the payload section 1720.

In this embodiment, instances of compression information 1712.1, 1712.2, . . . , 1712.n may be provided in the metadata headers 1710.1, 1710.2, . . . , 1710.n. These header-specific instances of compression information 1712.1, 1712.2, . . . , 1712.n may indicate whether their counterpart metadata payloads 1720.1, 1720.2, . . . , 1720.n have had compression applied. And, in instances where it is desired to allow individual metadata payloads 1720.1, 1720.2, . . . , 1720.n to be compressed using a compression algorithm that is different from a compression algorithm identified in the instance of group-wide compression information 1714, those metadata headers (say, 1710.1, and 1710.3) may include information identifying the compression algorithm that was used. As before, the semantics and syntax of compression information 1714, 1712.1, 1712.2, . . . , 1712.n may be tailored to suit individual implementation needs.

Payload compression may be performed cooperatively with any of the metadata group embodiments illustrated in FIGS. 4-12.

The foregoing discussion has described the various embodiments of the present disclosure in the context of source devices, destination devices, and functional units provided within them. In some applications, the functional blocks described hereinabove may be provided as elements of an integrated software system, in which the blocks may be provided as elements of a computer program, which are stored as program instructions in memory and executed by a general processing system. In other applications, the functional blocks may be provided as discrete circuit components of a processing system, such as functional units within a digital signal processor or application-specific integrated circuit. Still other applications of the present disclosure may be embodied as a hybrid system of dedicated hardware and software components. Moreover, the functional blocks described herein need not be provided as separate elements. The principles of the present disclosure find application in all such devices.

Further, the figures illustrated herein have provided only so much detail as necessary to present the subject matter of the present disclosure. In practice, source devices and destination devices typically will include functional units in addition to those described herein, including buffers to store data throughout the processing pipelines illustrated and communication transceivers to manage communication with the communication network and the counterpart devices. Such elements have been omitted from the foregoing discussion for clarity.

Several embodiments of the disclosure are specifically illustrated and/or described herein. However, it will be appreciated that modifications and variations of the disclosure are covered by the above teachings and within the purview of the appended claims without departing from the spirit and intended scope of the invention.

We claim:

1. A method of signaling metadata, comprising:
for each instance of metadata information to be signaled, providing, in sequence in a metadata group header section, a metadata unit header corresponding to a respective instance of the metadata information, and
providing, for each instance of the metadata information to be signaled, in sequence in a metadata group payload section, the respective instances of the metadata information in a respective metadata unit payload, each instance of metadata unit payload relating to a portion of media.

2. The method of claim 1, wherein the metadata unit header(s) provide information relating scope(s) of their corresponding metadata unit payload(s) to each other.

3. The method of claim 2, wherein information of at least one metadata unit header is derived from a metadata group preamble that precedes the respective metadata unit header in coding data.

4. The method of claim 1, wherein the metadata group header section has a marker, following a final metadata unit header in the metadata group header section, indicating an end of the metadata group header section.

5. The method of claim 1, wherein
the metadata unit headers each have a type element, and
for a final metadata unit header in the metadata unit header section, the type element indicates that it is the last metadata header in the metadata group.

6. The method of claim 1, wherein the metadata group header section has a count element identifying a number of metadata unit headers in the metadata group header section.

7. The method of claim 1, wherein the metadata group header section has an offset element identifying an offset between a start of the metadata group header section and a start of the metadata group payload section.

8. The method of claim 1, wherein each metadata unit header has a size element identifying a size of its respective metadata unit payload.

9. The method of claim 1, wherein at least one metadata unit header has a priority element identifying a relative priority of the metadata unit header with respect to other metadata unit header(s).

10. The method of claim 1, wherein the metadata unit header(s) appear in the metadata group header section in a descending order of priority with respect to other metadata unit header(s).

11. The method of claim 1, wherein at least one metadata unit header has a persistence element identifying a duration for which the respective metadata unit header is to be active.

12. The method of claim 1, wherein at least one metadata unit header has an application element identifying an application to which the respective metadata unit header corresponds.

13. The method of claim 1, wherein the metadata group header section has at least two metadata unit headers placed adjacent to each other in the metadata group header section that have application elements identifying a common application to which the two metadata unit headers correspond.

14. The method of claim 1, wherein at least one metadata unit header has a cancellation flag, that when active, indicates that the respective metadata unit header is canceled.

15. The method of claim 1, wherein at least one metadata unit header has a suspension flag, that when active, indicates that the respective metadata unit header is suspended.

16. The method of claim 1, wherein at least one metadata unit header has an activation flag, that when active, indicates that the respective metadata unit header is reactivated from a suspended state.

17. The method of claim 1, wherein the metadata group header section includes information indicating whether compression is applied to the metadata group payload section.

18. The method of claim 1, wherein data of at least one metadata unit payload is compressed by a compression algorithm.

19. A method for determining a metadata processing state, comprising:
parsing a metadata group header section of a metadata group to determine instances of metadata unit headers contained in the metadata group header section,
identifying the metadata unit header(s) that are relevant to a current decoding context, and
parsing a metadata group payload section for metadata unit payloads that correspond to the identified metadata unit header(s),
developing metadata processing state(s) from information in the instance(s) of metadata unit payloads that correspond to the identified metadata unit header(s), and
processing recovered video according to the processing state(s).

20. The method of claim 19, wherein the parsing of the metadata group header section is based on a marker, provided in the metadata group header section, that identifies a final metadata unit header in the metadata group header section.

21. The method of claim 19, wherein the parsing of the metadata group header section is based on type elements in the metadata unit headers, which, for a final metadata unit header in the metadata group header section, identifies the final metadata unit header in the metadata group header section.

22. The method of claim 19, wherein the parsing of the metadata group payload section is based on a count element identifying a number of metadata unit headers in the metadata group header section.

23. The method of claim 19, wherein the parsing of the metadata group payload section is based on an offset element, in the metadata group header section, identifying an offset between a start of the metadata group header section and a start of the metadata group payload section.

24. The method of claim 19, wherein the parsing of the metadata group payload section is based on a size element in the metadata unit header(s) identifying a size of its respective metadata unit payload.

25. The method of claim 19, wherein the developing is based on a priority element, provided in at least one identified metadata unit header, identifying a relative priority of the respective metadata unit header with respect to other metadata unit header(s).

26. The method of claim 19, wherein the developing is based on a persistence element, provided in at least one identified metadata unit header, identifying a duration for which the respective metadata unit header is to be active.

27. The method of claim 19, wherein the identifying is based on an application element, provided in at least one identified metadata unit header, identifying an application to which the respective metadata unit header corresponds.

28. The method of claim 19, wherein the developing is based on a cancellation flag, provided in at least one identified metadata unit header, indicating that the respective metadata unit header is canceled.

29. The method of claim 19, wherein the developing is based on a suspension flag, provided in at least one identified metadata unit header, indicating that the respective metadata unit header is suspended.

30. The method of claim 19, wherein the developing is based on an activation flag, provided in at least one identified metadata unit header, indicating that the respective metadata unit header is reactivated from a suspended state.

31. The method of claim 19, wherein the metadata group header section includes information indicating whether compression is applied to the metadata group payload section.

32. The method of claim 19, further comprising decompressing at least one instance of the metadata unit payload(s).

33. A method of signaling metadata, comprising:
for each instance of metadata information to be signaled, providing a metadata unit header containing information regarding a scope of the metadata information with respect to media to which it relates, and a metadata unit payload providing the metadata information,
placing the metadata unit header(s) and metadata unit payload(s) into a metadata group element, and
interleaving the metadata group element and compressed data representing the media into coding data for the media.

34. The method of claim 33, wherein
the metadata unit header(s) each have a type element, and
for a final metadata unit header in the metadata group element, the type element indicates that it is the last metadata unit header in the metadata group element.

35. The method of claim 33, wherein the metadata group element has a count element identifying a number of metadata unit headers.

36. The method of claim 33, wherein each metadata unit header has a size element identifying a size of the respective metadata unit header and its associated metadata unit payload.

37. The method of claim 33, wherein at least one metadata unit header has a priority element identifying a relative priority of the metadata unit header with respect to other metadata unit header(s).

38. The method of claim 33, wherein at least one metadata unit header has a persistence element identifying a duration for which the respective metadata unit header is to be active.

39. The method of claim 33, wherein at least one metadata unit header has an application element identifying an application to which the respective metadata unit header corresponds.

40. The method of claim 33, wherein at least one metadata unit header has a cancellation flag, that when active, indicates that the respective metadata unit header is canceled.

41. The method of claim 33, wherein at least one metadata unit header has a suspension flag, that when active, indicates that the respective metadata unit header is suspended.

42. The method of claim 33, wherein at least one metadata unit header has an activation flag, that when active, indicates that the respective metadata unit header is reactivated from a suspended state.
